(19) United States
(12) Patent Application Publication
(10) Pub. No.: US 2005/0230042 A1
(43) Pub. Date: Oct. 20, 2005

(54) Bonding structure and method for bonding members

(76) Inventor: Nobuaki Hashimoto, Suwa-shi (JP)

Correspondence Address: HARNESS, DICKEY & PIERCE, P.L.C., P.O. BOX 828, BLOOMFIELD HILLS, MI, 48303, US

(21) Appl. No.: 10/996,356

(22) Filed: Nov. 23, 2004

(30) Foreign Application Priority Data
Jan. 5, 2004 (JP) 2004-000112

(51) Int. Cl. B32B 31/00

(52) U.S. Cl. 156/279; 156/307.1; 156/325

(57) ABSTRACT

A bonding structure includes members; nanoparticles bonding the members; and a receiving layer disposed on at least one of the members, holding the nanoparticles. Another bonding structure includes members; nanoparticles bonding the members; and a receiving structure formed on a surface of at least one of the members, holding the nanoparticles.

### BACKGROUND OF THE INVENTION

1. Field of the Invention

The present invention relates to bonding structures and methods for bonding members and, particularly, to a bonding structure and method for bonding members with nanoparticles.

2. Description of the Related Art

In a known microelectromechanical system (MEMS) according to, for example, PCT Japanese Translation Patent Publication No. 2003-519378 (see FIG. 1 of this publication), a first layer and a second layer are electrically connected by allowing fine conductive crystal grains to grow between these layers.

According to another known bonding structure and method, members are bonded with nanoparticles disposed therebetween.

The method by allowing the fine conductive crystal grains to grow, however, cannot be applied to general bonding of members (for example, the bonding of semiconductor devices and substrates) in view of structure and strength.

This bonding structure and method using the nanoparticles undesirably exhibit low bonding reliability because the members, which are bonded using nanoparticles alone as an adhesive, generally have insufficient bonding strength.

### SUMMARY OF THE INVENTION

An object of the present invention is therefore to provide a bonding structure and method that provide high bonding reliability and cause less damage to the members bonded.

The present invention provides a bonding structure including members; nanoparticles bonding the members; and a receiving layer disposed on at least one of the members, holding the nanoparticles.

The members can be bonded with nanoparticles having a low melting point at a relatively low temperature and therefore suffer less damage. In addition, the receiving layer holding the nanoparticles is provided on at least one of the members, so that the members can attain higher bonding strength. This, bonding structure therefore enables the bonding of members that are conventionally difficult to bond.

In this bonding structure, there may be two members, and the receiving layer is preferably disposed on each of the two members.

If the receiving layer is disposed on each of the two members, the bonding reliability between the two members can be further enhanced by, for example, applying the nanoparticles onto both receiving layers.

The present invention further provides a bonding structure including members; and nanoparticles bonding the members, wherein at least one of the members is a receiving layer holding the nanoparticles.

Because at least one of the members is a receiving layer for holding the nanoparticles, the nanoparticles may be directly applied onto this member to bond the members more reliably.

The present invention further provides a bonding structure including members; nanoparticles bonding the members; and a receiving structure formed on a surface of at least one of the members, holding the nanoparticles.

Because the receiving structure for holding the nanoparticles is formed on a surface of at least one of the members, the members can attain higher bonding strength as in the above bonding structures including the receiving layer.

In this bonding structure, the receiving structure may be formed by chemically or physically modifying the surface.

As an example of chemically modifying methods, hydrophilic groups may be introduced to the surface to its ability to hold the nanoparticles, thereby enhancing the bonding strength between the members.

The present invention further provides a bonding structure including members; nanoparticles bonding the members; and a receiving layer disposed on at least one of the members, containing the nanoparticles.

The members can be bonded with nanoparticles having a low melting point at a relatively low temperature and therefore suffer less damage. In addition, the receiving layer containing the nanoparticles is provided on at least one of the members, so that the members can attain higher bonding strength. This bonding structure therefore enables the bonding of members that are conventionally difficult to bond.

In the above bonding structures, the nanoparticles may be partially or completely fused.

If the nanoparticles are partially or completely fused by, for example, heating, the above bonding structures can attain higher bonding strength.

In the above bonding structures, the nanoparticles may contain a metal.

If nanoparticles containing a metal are used, the members can be bonded with higher bonding strength at low cost.

In the above bonding structures, the nanoparticles may be made of gold, silver, or copper.

If gold, silver, or copper nanoparticles are used, the members can be bonded with higher bonding strength. In addition, such nanoparticles are readily available and contribute to cost reduction.

The present invention further provides a method for bonding members with nanoparticles. This method includes the steps of providing a receiving layer on a surface of at least one of the members; applying the nanoparticles onto a surface of the receiving layer; bringing the members into contact with each other; and heating the members.

The members can be bonded with nanoparticles having a low melting point at a relatively low heating temperature and therefore suffer less damage. In addition, the nanoparticles are applied onto a surface of a receiving layer provided on at least one of the members, so that the members can attain higher bonding strength. This bonding method therefore enables the bonding of members that are conventionally difficult to bond.

In this bonding method, there may be two members, and the receiving layer is preferably provided on each of the two members.

If the receiving layer is disposed on each of the two members, the bonding reliability between the two members can be further enhanced by, for example, applying the nanoparticles onto both receiving layers.

The present invention provides another method for bonding members with nanoparticles. This method includes the steps of applying the nanoparticles onto a surface of at least one of the members that is a receiving layer; bringing the members into contact with each other; and heating the members.

Because at least one of the members is a receiving layer for holding the nanoparticles, the nanoparticles may be directly applied onto this member to bond the members more reliably.

The present invention provides another method for bonding members with nanoparticles. This method includes the steps of forming a receiving structure on a surface of at least one of the members; applying the nanoparticles onto the receiving structure; bringing the members into contact with each other; and heating the members.

Because the receiving structure for holding the nanoparticles is formed on a surface of at least one of the members, the members can attain higher bonding strength as in the above bonding methods using the receiving layer.

In this bonding method, the receiving structure may be formed by chemically or physically modifying the surface.

As an example of chemically modifying methods, hydrophilic groups may be introduced to the surface to its ability to hold the nanoparticles, thereby enhancing the bonding strength between the members.

The present invention provides another method for bonding members with nanoparticles. This method includes the steps of providing a receiving layer containing the nanoparticles onto at least one of the members; bringing the members into contact with each other; and heating the members.

The members can be bonded with nanoparticles having a low melting point at a relatively low heating temperature and therefore suffer less damage. In addition, the receiving layer containing the nanoparticles is provided on at least one of the members, so that the members can attain higher bonding strength. This bonding method therefore enables the bonding of members that are conventionally difficult to bond.

In the above bonding methods, the nanoparticles may be partially or completely fused.

If the nanoparticles are partially or completely fused by, for example, heating, a bonding structure having higher bonding strength can be achieved.

In the above bonding methods, the nanoparticles may contain a metal.

If nanoparticles containing a metal are used, the members can be bonded with higher bonding strength at low cost.

In the above bonding methods, the nanoparticles may be made of gold, silver, or copper.

If gold, silver, or copper nanoparticles are used, the members can be bonded with higher bonding strength. In addition, such nanoparticles are readily available and contribute to cost reduction.

In the above bonding methods, the nanoparticles may be coated with a dispersant before the heating.

If the nanoparticles are coated with a dispersant before the heating, they can be applied onto, for example, the receiving layer while keeping them stable.

In the above bonding methods, the nanoparticles may be applied onto the surface of the receiving layer by inkjetting.

Using inkjetting, the nanoparticles can be uniformly and accurately applied onto the surface of the receiving layer.

In the above bonding methods, the nanoparticles may be applied onto the surface of the receiving layer by printing.

Using, for example, screen printing, the nanoparticles can be uniformly and accurately applied onto the surface of the receiving layer.

In the above bonding methods, the nanoparticles may be applied onto the surface of the receiving layer by transfer.

The nanoparticles can be applied onto the surface of the receiving layer uniformly and accurately as in, for example, inkjetting by placing the nanoparticles onto, for example, a flat plate and transferring them.

In the above bonding methods, the nanoparticles may be applied onto the surface of the receiving layer by dropping.

Using dropping, the nanoparticles can be applied onto a larger area of the surface of the receiving layer for a short time than using, for example, inkjetting.

In the above bonding methods, the members may be pressurized simultaneously with the heating.

The pressurization simultaneous with the heating can further enhance the bonding reliability between the members.

### BRIEF DESCRIPTION OF THE DRAWINGS

FIGS. 1A to 1D are schematic longitudinal sectional views showing the bonding steps of a method for bonding members according to a first embodiment of the present invention;

FIGS. 2A and 2B are schematic longitudinal sectional views showing the bonding steps of a method for bonding members according to a second embodiment of the present invention; and

FIG. 3 shows an example of a product having a bonding structure according to a third embodiment of the present invention.

### DESCRIPTION OF THE PREFERRED EMBODIMENTS

### First Embodiment

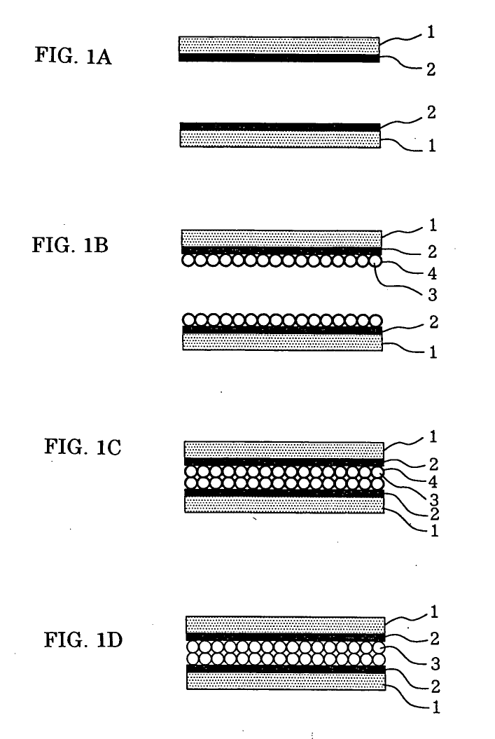

FIGS. 1A to 1D are schematic longitudinal sectional views showing the bonding steps of a method for bonding members according to a first embodiment of the present invention. Two members are bonded in FIGS. 1A to 1D, though this method may also be applied to the bonding of three or more members, for example the bonding of semiconductor devices to a substrate.

Referring to FIG. 1A, a receiving layer 2 is formed on each of two members 1. Examples of the material for the members 1 include metals, glass, synthetic resins, and semiconductors; substantially any solid may be used for the members 1 in the bonding structure and method of this embodiment. The members 1, which are flat in FIGS. 1A to 1D, may have a different shape. In addition, the two members 1 may be made of different materials, and may have, for example, wiring disposed thereon.

Typical examples of the material for the receiving layer 2 include polyamic acids, acrylic resin, alumina hydrate, calcium carbonate, magnesium carbonate, synthesized silica microparticles, talc, kaolin, calcium sulfate, and barium sulfate. The receiving layer 2 is formed by, for example, application or spraying using a machine. A surface of each member 1 may be roughened before the formation of the receiving layers 2 on the members 1 to enhance the adhesion between the members 1 and the receiving layers 2.

Referring to FIG. 1B, nanoparticles 3 coated with a dispersant 4 are applied onto the receiving layers 2 formed on the members 1. The nanoparticles 3 have a diameter of about 10 nm and are usually made of a metal such as gold, silver, or copper. Such nanoparticles 3 provide higher bonding strength between the members 1. The dispersant 4 serves to protect the nanoparticles 3 and keep them stable before heating. The dispersant 4 used is exemplified by various hydrocarbons.

The nanoparticles 3 coated with the dispersant 4 are, for example, mixed into a solvent to apply them onto the receiving layers 2 in paste or ink form. Such a paste or ink of the nanoparticles 3 may be applied by, for example, inkjetting, printing, transfer, or dropping. In inkjetting, jets of a solvent containing the nanoparticles 3 are applied with an inkjet head. In printing, a solvent containing the nanoparticles 3 is applied by, for example, screen printing. In transfer, the nanoparticles 3 are applied by placing the nanoparticles 3 onto a flat plate and transferring them, where the nanoparticles 3 need not necessarily be mixed into a solvent to apply them in paste or ink form. In dropping, a solvent containing the nanoparticles 3 is applied dropwise using, for example, a dispenser.

Referring to FIG. 1C, the members 1 having the nanoparticles 3 applied on the receiving layers 2 in FIG. 1B are brought into contact with each other. The nanoparticles 3, which are protected by the dispersant 4, are stably held by the receiving layers 2.

Referring to FIG. 1D, the two members 1 brought into contact with each other in FIG. 1C are heated to partially or completely fuse the nanoparticles 3 applied onto the receiving layers 2 and bond the fused nanoparticles 3 and the receiving layers 2. As a result, the members 1 are bonded. The members 1 may be heated at low temperature, for example about 150° C. to 200° C., because the nanoparticles 3 have high reactivity due to a large surface area relative to volume. The nanoparticles 3, which remain unchanged in shape in FIG. 1D, are partially or completely fused and coupled in practice.

In the step of heating the members 1 in FIG. 1D, generally, the major part of the dispersant 4 coating the nanoparticles 3 often evaporates off.

The members 1 may be pressurized simultaneously with the heating in FIG. 1D to enhance the bonding strength between the members 1. In addition, the nanoparticles 3, which are applied onto the receiving layers 2 disposed on the two members 1 in FIGS. 1A to ID, may be applied only onto either receiving layer 2.

The receiving layers 2 are provided on the two members 1 in FIGS. 1A to 1D; in the present invention, a receiving layer may be provided on at least one of, for example, three or more members.

In addition, at least one of the members 1 may be the receiving layer 2. This member 1 is made of, for example, a polyamic acid. In this case, the member 1 requires no receiving layer made of a different material.

Furthermore, at least one of the receiving layers 2 provided on the members 1 may contain the nanoparticles 3. The receiving layer 2 containing the nanoparticles 3 may be formed by, for example, mixing a polyamic acid powder and the nanoparticles 3 and applying or spraying the mixture. The nanoparticles 3 need not be applied onto a surface of the receiving layer 2 containing the nanoparticles 3. The members 1 may be bonded by, for example, bringing the receiving layers 2 into contact with each other and heating the members 1.

In the first embodiment, the members 1 can be bonded with nanoparticles having a low melting point at a relatively low temperature and therefore suffer less damage. In addition, the receiving layer 2 holding the nanoparticles 3 is provided on at least one of the members 1, so that the members 1 can attain higher bonding strength. This bonding structure and method therefore enable the bonding of members that are conventionally difficult to bond.

The bonding reliability between the two members 1 can be further enhanced by providing the receiving layer 2 on each of the two members 1 and applying the nanoparticles 3 onto both receiving layers 2.

The same advantages as the above bonding structure can also be achieved if at least one of the members 1 is the receiving layer 2 or at least one of the receiving layers 2 provided on the members 1 contains the nanoparticles 3.

### Second Embodiment

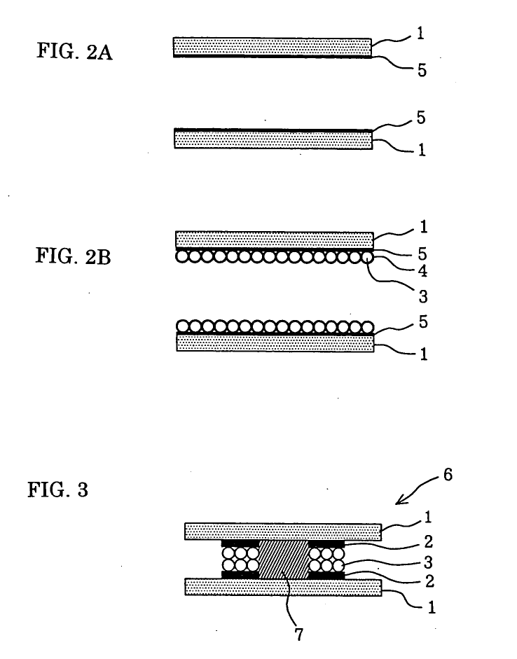

FIGS. 2A and 2B are schematic longitudinal sectional views showing the bonding steps of a method for bonding members according to a second embodiment of the present invention. In the second embodiment, a receiving structure 5 for holding the nanoparticles 3 is formed on the members 1 instead of the receiving layer 2 in the first embodiment. In the second embodiment, the bonding steps in FIGS. 1A and 1B in the first embodiment are replaced by those in FIGS. 2A and 2B, and the subsequent bonding steps are the same as those in FIGS. 1C and 1D. The other features of the second embodiment are the same as those of the first embodiment. In the following description, the same parts as in the first embodiment are indicated by the same reference numerals.

Referring to FIG. 2A, the receiving structure 5 is formed on each of the two members 1. Examples of the material for the members 1 include metals, glass, synthetic resins, and semiconductors; substantially any solid may be used for the members 1 as in the first embodiment. The members 1, which are flat in FIGS. 2A and 2B, may have a different shape. In addition, the two members 1 may be made of different materials, and may have, for example, wiring disposed thereon. The receiving structure 5 may be formed on at least one of the members 1 as in the first embodiment.

The receiving structure 5 may be any structure that can enhance the wettability of, for example, a solvent containing the nanoparticles 3 in paste or ink form. The receiving structure 5 may be formed by, for example, chemically or physically modifying a surface of the members 1. As examples of chemically modifying methods, hydrophilic groups may be introduced to a surface of the members 1 by an oxidation or hydroxylation process, or a coupling agent may be applied onto the surface. As examples of physically modifying methods, a surface of the members 1 may be roughened by mechanical or chemical polishing, or may be irradiated with electron beams or light to enhance its surface energy.

The receiving structure 5 may also be formed by depositing an organic or inorganic material onto a surface of the members 1 by, for example, evaporation or sputtering, or may be formed by electrolytic or electroless plating. The material used for the receiving structure 5 may be any material that can enhance the wettability of, for example, the above solvent.

Referring to FIG. 2B, the nanoparticles 3 coated with the dispersant 4 are applied onto the receiving structures 5 formed on the members 1 as in the first embodiment. The subsequent bonding steps are the same as those in FIGS. 1C and 1D in the first embodiment.

In the second embodiment, the receiving structure 5 holding the nanoparticles 3 is provided on a surface of at least one of the members 1. The members 1 can therefore attain higher bonding strength as in the bonding structure including the receiving layer 2 according to the first embodiment.

### Third Embodiment

FIG. 3 shows an example of a product having a bonding structure according to a third embodiment of the present invention. Referring to FIG. 3, a liquid crystal panel 6 includes the members 1 bonded by the bonding method according to the first embodiment. As in FIG. 3, for example, the bonding structures according to the first and second embodiments of the present invention may be applied to a sealing structure for sealing a liquid crystal 7 in the liquid crystal panel 6.

1. A bonding structure comprising:
members;
nanoparticles bonding the members; and
a receiving layer disposed on at least one of the members, holding the nanoparticles.

2. The bonding structure according to claim 1, wherein
there are two members; and
the receiving layer is disposed on each of the two members.

3. A bonding structure comprising:
members; and
nanoparticles bonding the members,
wherein at least one of the members is a receiving layer holding the nanoparticles.

4. A bonding structure comprising:
members;
nanoparticles bonding the members; and
a receiving structure formed on a surface of at least one of the members, holding the nanoparticles.

5. The bonding structure according to claim 4, wherein the receiving structure is formed by chemically or physically modifying the surface.

6. A bonding structure comprising:
members;
nanoparticles bonding the members; and
a receiving layer disposed on at least one of the members, containing the nanoparticles.

7. The bonding structure according to claim 6, wherein the nanoparticles are partially or completely fused.

8. The bonding structure according to claim 7, wherein the nanoparticles comprise a metal.

9. The bonding structure according to claim 8, wherein the nanoparticles comprise gold, silver, or copper.

10. A method for bonding members with nanoparticles, comprising the steps of:
providing a receiving layer on a surface of at least one of the members;
applying the nanoparticles onto a surface of the receiving layer;
bringing the members into contact with each other; and
heating the members.

11. The method for bonding members according to claim 10, wherein
there are two members; and
the receiving layer is disposed on each of the two members.

12. A method for bonding members with nanoparticles, comprising the steps of:
applying the nanoparticles onto a surface of at least one of the members that is a receiving layer;
bringing the members into contact with each other; and
heating the members.

13. A method for bonding members with nanoparticles, comprising the steps of:
forming a receiving structure on a surface of at least one of the members;
applying the nanoparticles onto the receiving structure;
bringing the members into contact with each other; and
heating the members.

14. The method for bonding members according to claim 13, wherein the receiving structure is formed by chemically or physically modifying the surface.

15. A method for bonding members with nanoparticles, comprising the steps of:
providing a receiving layer containing the nanoparticles onto at least one of the members;
bringing the members into contact with each other; and
heating the members.

16. The method for bonding members according to claim 15, wherein the nanoparticles are partially or completely fused.

17. The method for bonding members according to claim 16, wherein the nanoparticles comprise a metal.

18. The method for bonding members according to claim 17, wherein the nanoparticles comprise gold, silver, or copper.

19. The method for bonding members according to claim 18, wherein the nanoparticles are coated with a dispersant before the heating.

20. The method for bonding members according to claim 10, wherein the nanoparticles are applied onto the surface of the receiving layer by inkjetting.

21. The method for bonding members according to claim 10, wherein the nanoparticles are applied onto the surface of the receiving layer by printing.

22. The method for bonding members according to claim 10, wherein the nanoparticles are applied onto the surface of the receiving layer by transfer.

23. The method for bonding members according to claim 10, wherein the nanoparticles are applied onto the surface of the receiving layer by dropping.

24. The method for bonding members according to claim 10, wherein the members are pressurized simultaneously with the heating.
